(19) United States
(12) Patent Application Publication
(10) Pub. No.: US 2007/0066094 A1
(43) Pub. Date: Mar. 22, 2007

(54) Package having balls designed to reduce contact resistance, test apparatus for testing the package, and method of manufacturing the package

(75) Inventors: Jung-hye Kim, Yongin-si (KR); Sang-moon Lee, Yongin-si (KR); Il-chan Park, Hwaseong-si (KR); Byung-wook Ahn, Hwaseong-si (KR)

Correspondence Address: MILLS & ONELLO LLP, ELEVEN BEACON STREET, SUITE 605, BOSTON, MA, 02108, US

(73) Assignee: Samsung Electronics Co., Ltd.

(21) Appl. No.: 11/517,493

(22) Filed: Sep. 7, 2006

(30) Foreign Application Priority Data
Sep. 22, 2005 (KR) 10-2005-0088241

(51) Int. Cl. H01R 12/00

(52) U.S. Cl. 439/71

(57) ABSTRACT

Provided are an integrated circuit (IC) package having balls designed to minimize contact resistance, a test apparatus for testing the IC package, and a method of manufacturing the IC package. The IC package is a ball grid array (BGA) package including solder balls, the solder balls having substantially flat bottoms. The balls of the BGA package are Pb-free balls, and are polished using a mechanical polishing method or a chemical polishing method to have the substantially flat bottoms. The test apparatus includes a plurality of channels, a test board having a wiring pattern connected to the channels, and an IC socket having a plurality of Pogo pins respectively connected to lands of the wiring pattern. The top ends of the Pogo pins of the IC socket are made substantially flat to increase the area that contacts the substantially flat bottom surfaces of the BGA package.

### CROSS-REFERENCE TO RELATED PATENT APPLICATIONS

This application claims the benefit of Korean Patent Application No. 10-2005-0088241, filed on Sep. 22, 2005, in the Korean Intellectual Property Office, the contents of which are incorporated herein in their entirety by reference.

### BACKGROUND OF THE INVENTION

1. Field of the Invention

The present invention relates to a package of a semiconductor device and a socket, and more particularly, to package balls designed to minimize contact resistance, an integrated circuit (IC) socket, and a method of manufacturing the package.

2. Description of the Related Art

A ball grid array (BGA) package type integrated circuit (IC) device undergoes an electrical property test when being inserted into an IC socket during a package test. In the package test, a BGA package is inserted into the. IC socket and tested using a handler and a conversion kit while applying a force of a certain level to an upper portion of the BGA package.

In package test environments, when locations of a ball pad of the BGA package IC device and a socket pad of the IC socket do not match each other or balls have different heights, a difference in contact resistance between the two pads may be generated according to the force with which the upper portion of the BGA package is pressed down. Japanese Patent Publication No. 2005-19343 discloses an IC socket used in an electrical property test process, such as a final test process.

FIG. 1 illustrates a conventional BGA package 140 mounted on a Pogo type IC socket 120 to undergo a test. Referring to FIG. 1, the Pogo type IC socket 120 is mounted on a test board 110. Pogo pins 130 installed within the IC socket 120 connect lands 112 of a wiring pattern of the test board 110 to balls 142 of the BGA package 140.

Recently in Europe, “Restrictions on Harmful Chemical Materials,” has been issued, in which only electronic products that do not include six materials harmful to a human body, namely, Pb, Cd, Hg, Cr⁶⁺, PBB, and PBDE, should be manufactured and sold after July of 2006. The manufacture of Pb-free products is being promoted. Hence, the balls 142 of the BGA package 140 are formed using a Pb-free soldering method. The Pogo pins 130 have a crown-shaped leading end A to increase a surface that contacts the balls 142 of the BGA package 140.

However, the balls 142 of the BGA package 140 are damaged by the Pogo pins 130 in contact with the balls 142 during the test, and thus the balls 142 become detached. The balls 142 detached from the Pogo pins 130 degrade the tester.

FIG. 2 illustrates a conventional BGA package 240 mounted on a rubber type IC socket 220 to undergo a test. Referring to FIG. 2, the rubber type IC socket 220 does not damage balls 242 of the BGA package 240. The rubber type IC socket 220 has electrode pads 224 arranged to face the balls 242, and is mounted on a test board 210. The electrode pads 224 are arranged on the surface of a rubber plate 230 on the IC socket 220. The electrode pads 224 are connected to lands 212 of a wiring pattern of the test board 210 via conductive elements 222.

However, due to the weak elasticity of the rubber type IC socket 220, when the balls 242 of the BGA package 240 have different heights, the contact of the balls 242 of the BGA package 240 with the electrode pads 224 is degraded as shown in FIG. 3.

There remains a demand for a stable contact between the balls of a BGA package and electrode pads.

### SUMMARY OF THE INVENTION

The present invention provides a ball grid array (BGA) package having balls polished to have flat bottoms.

The present invention also provides a test apparatus including an integrated circuit (IC) socket on which the BGA package is mounted.

The present invention also provides a method of manufacturing the BGA package.

According to a first aspect, the present invention is directed to an integrated circuit (IC) package comprising soldered balls, wherein the solder balls have substantially flat bottoms.

In one embodiment, the balls are Pb-free balls.

In one embodiment, the balls are polished using a mechanical polishing method or a chemical polishing method to have the substantially flat bottoms.

In one embodiment, the IC package is a ball grid array package.

According to another aspect, the invention is directed to a test apparatus comprising a plurality of channels. A test board having a wiring pattern is connected to the channels. An IC socket includes a plurality of Pogo pins respectively connected to lands of the wiring pattern. An IC package includes balls having substantially flat bottoms contacting the Pogo pins.

In one embodiment, the Pogo pins of the IC socket have top ends that contact the balls of the ball grid array package, and the top ends are substantially flat.

In one embodiment, the Pogo pins of the IC socket include springs.

In one embodiment, the balls of the IC package are Pb-free balls.

In one embodiment, the balls of the IC package are polished using a mechanical polishing method or a chemical polishing method to have the substantially flat bottoms.

In one embodiment, the IC package is a ball grid array package.

According to another aspect, the invention is directed to a test apparatus comprising a plurality of channels. A test board having a wiring pattern is connected to the channels. An IC socket has a plurality of Pogo pins respectively connected to lands of the wiring pattern. A-rubber plate includes-conductive elements contacting the Pogo pins, electrode pads being disposed on the conductive elements. An IC package has balls having substantially flat bottoms contacting the electrode pads of the rubber plate.

In one embodiment, the Pogo pins of the IC socket have top ends that contact the balls of the ball grid array package, and the top ends are substantially flat.

In one embodiment, the Pogo pins of the IC socket include springs.

In one embodiment, the balls of the IC package are Pb-free balls.

In one embodiment, the balls of the IC package are polished using a mechanical polishing method or a chemical polishing method to have the substantially flat bottoms.

In one embodiment, the IC package is a ball grid array package.

According to another aspect, the invention is directed to a method of manufacturing an IC package. According to the method, ball grid array balls are soldered on a wafer that has completed a semiconductor manufacturing process. Bottom surfaces of the ball grid array balls are leveled. The wafer having the ball grid array balls whose bottom surfaces are leveled is vertically and horizontally sawed.

In one embodiment, the leveling is performed using a mechanical polishing method or a chemical polishing method.

In one embodiment, the vertically and horizontally sawing is performed using a diamond cutting method.

### BRIEF DESCRIPTION OF THE DRAWINGS

The foregoing and other objects, features and advantages of the invention will be apparent from the more particular description of preferred aspects of the invention, as illustrated in the accompanying drawings in which like reference characters refer to the same parts throughout the different views. The drawings are not necessarily to scale, emphasis instead being placed upon illustrating the principles of the invention. In the drawings, the thickness of layers and regions are exaggerated for clarity.

FIG. 1 illustrates a conventional ball grid array (BGA) package mounted on a Pogo type integrated circuit (IC) socket.

FIG. 2 illustrates a conventional BGA package mounted on a rubber type IC socket.

FIG. 3 illustrates contacts of BGA package balls with the rubber type IC socket shown in FIG. 2.

FIG. 4 illustrates balls of a BGA package according to an embodiment of the present invention.

FIG. 5 illustrates an IC socket according to another embodiment of the present invention.

FIGS. 6A through 6D illustrate a method of manufacturing the BGA package of FIG. 4.

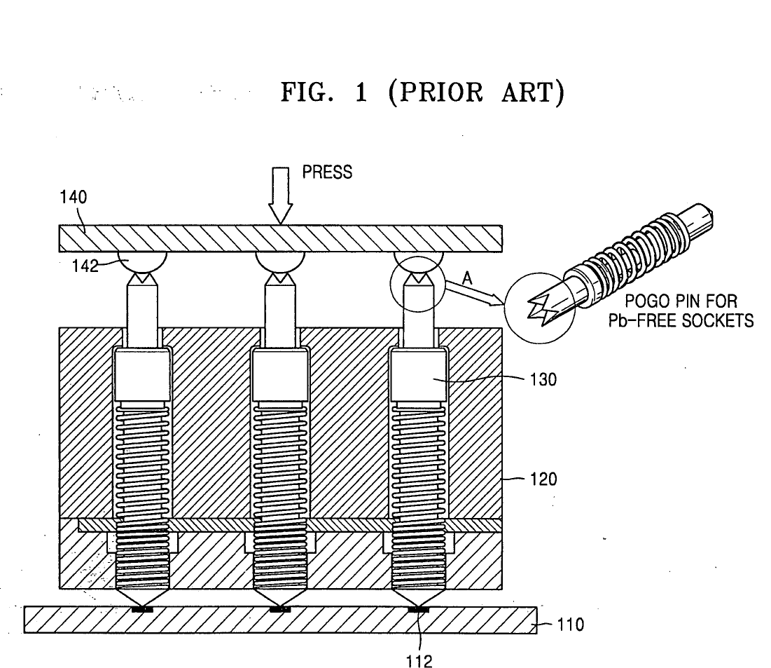

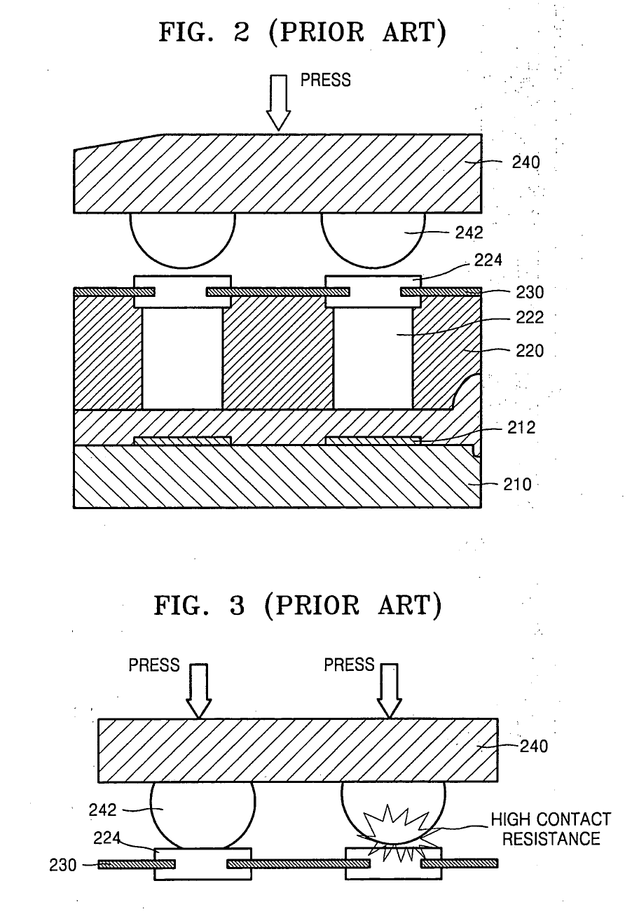

### DETAILED DESCRIPTION OF THE INVENTION

The attached drawings for illustrating preferred embodiments of the present invention are referred to in order to gain a sufficient understanding of the present invention, the merits thereof, and the objectives accomplished by the implementation of the present invention.

Hereinafter, the present invention will be described in detail by describing preferred embodiments of the invention with reference to the attached drawings.

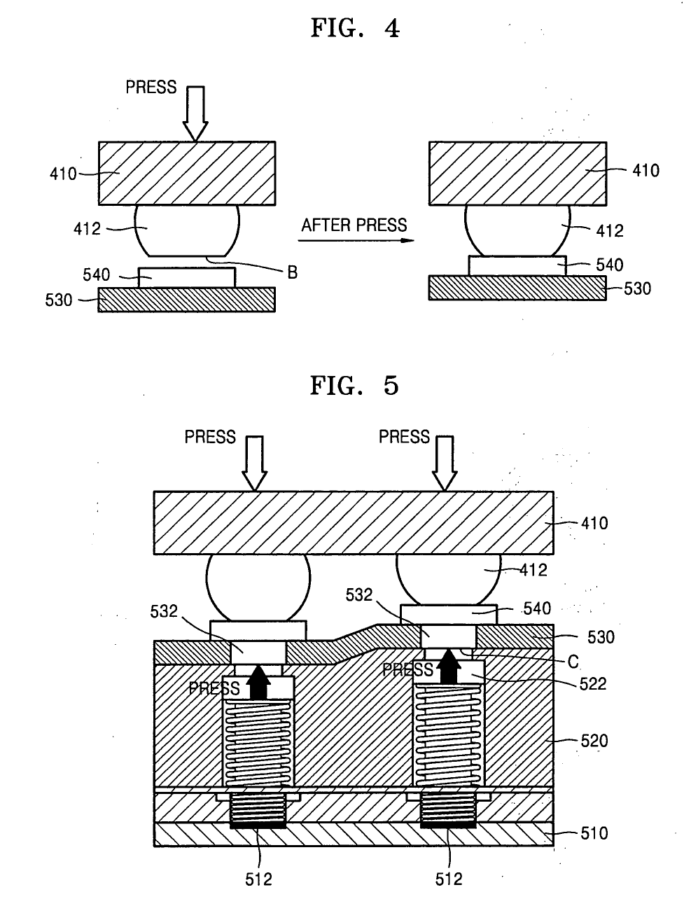

FIG. 4 illustrates balls of a ball grid array (BGA) package 410 according to an embodiment of the present invention. Referring to FIG. 4, balls 412 of the BGA package 410 have substantially flat bottoms B. The balls 412 of the BGA package 410 may be Pb-free balls. When the top portion of the BGA package 410 is pressed down, the entire bottom surfaces of the balls 412 of the BGA package 410 uniformly contact electrode pads 540 of a rubber plate 530. The balls 412 of the BGA package 410 are leveled up using a mechanical polishing process or a chemical polishing process.

FIG. 5 illustrates an IC socket 520 according to another embodiment of the present invention. Referring to FIG. 5, the BGA package 410, which is a type of an IC package, the IC socket 520, and a test board 510 constitute a test apparatus. The IC socket 520 includes Pogo pins 522 and is mounted on the test board 510. The Pogo pins 522 are connected to lands 512 of a wiring pattern of the test board 510 in a one-to-one correspondence. The wiring pattern of the test board 510 is connected to channels of the test apparatus. The top ends C of the Pogo pins 522 are leveled up. Springs are installed inside the Pogo pins 522. The top ends C of the Pogo pins 522 contact the bottom surfaces of the balls 412 of the BGA package 410 via conductive elements 532 inside the rubber plate 530.

Due to a force applied onto the upper portion of the BGA package 410 and the elasticity of the springs of the Pogo pins 522, contacts of the bottom surfaces of the balls 412 of the BGA package 410 with the top ends of the Pogo pins 522 improve.

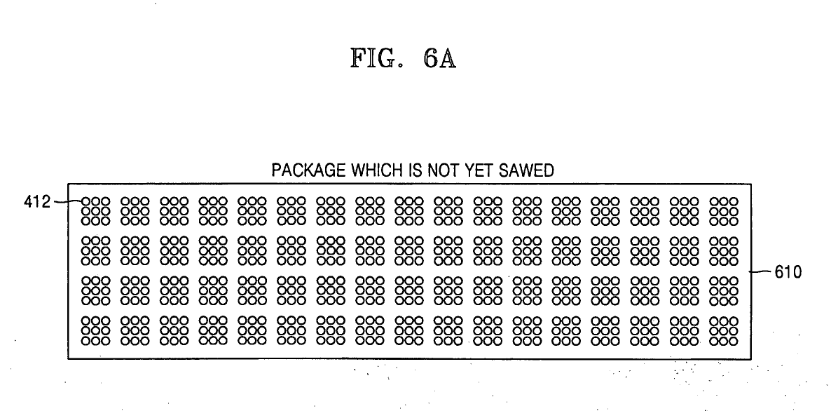

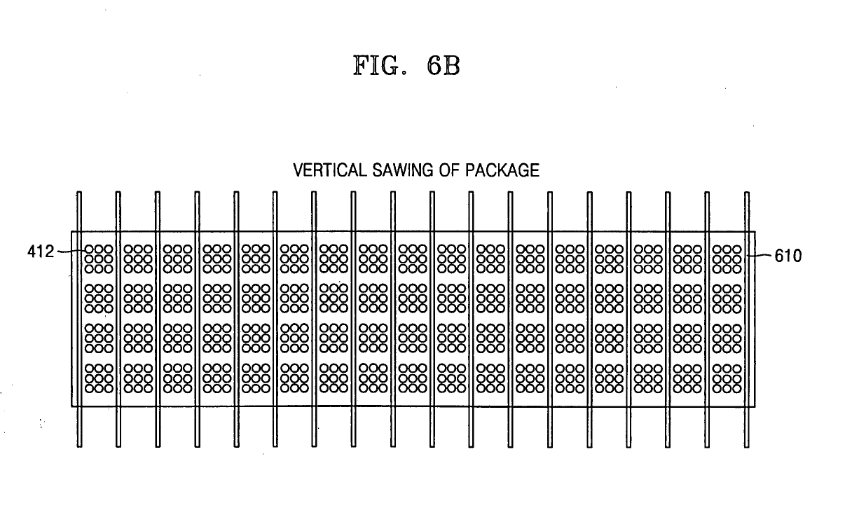

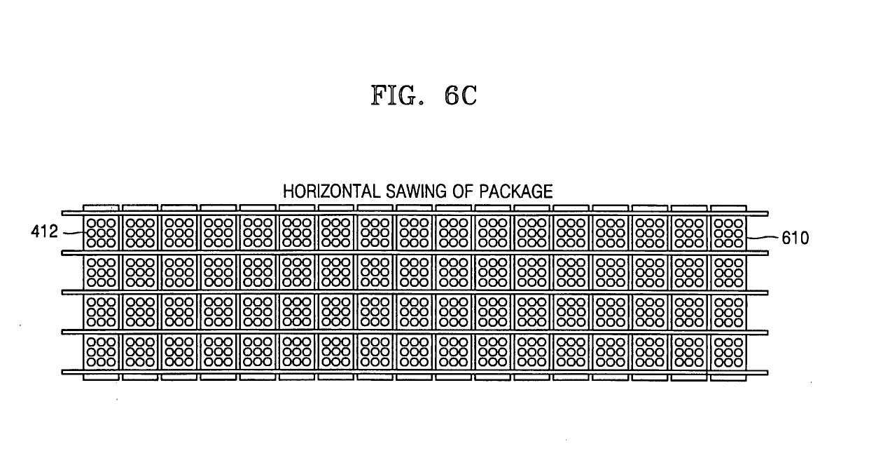

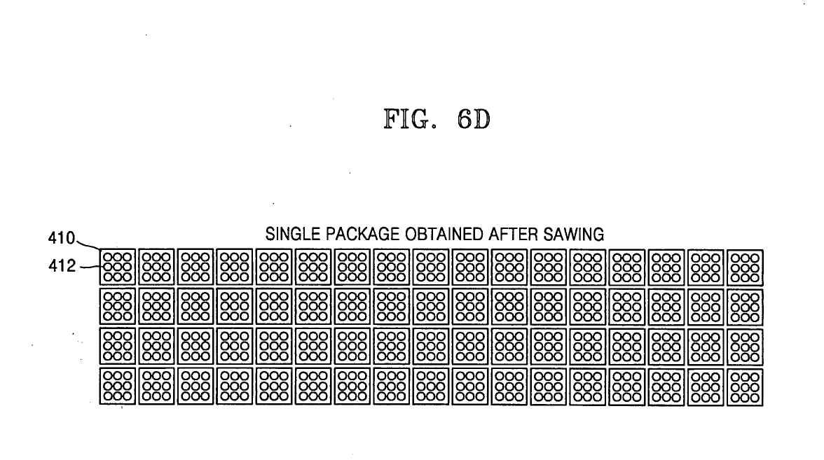

FIGS. 6A through 6D illustrate a method of manufacturing the BGA package 410. In FIG. 6A, the balls 412 are soldered on a wafer 610, which has completed a semiconductor manufacturing process. Thereafter, round bottoms of the balls 412 are polished to be level, i.e., at the same height, and to have substantially flat bottom surfaces.

The balls 412 can be leveled using a mechanical polishing method. In some cases, the balls 412 can be leveled using both a chemical polishing method and the mechanical polishing method. These polishing processes are performed using a polisher (not shown). The polisher has a predetermined surface roughness and removes the round bottoms of the balls 412 using a mechanical friction with the surfaces of the balls 412 due to rotation.

Referring to FIG. 6B, the wafer 610 having the balls 412 having the substantially flat bottoms formed thereon is sawed vertically. The sawing can be performed using a diamond cutting method.

Referring to FIG. 6C, the vertically sawed wafer 610 is sawed horizontally. Thus, the BGA package 410 is completed as shown in FIG. 6D. The BGA package 410 has balls 412 with substantially flat bottoms.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An integrated circuit (IC) package comprising soldered balls, wherein the solder balls have substantially flat bottoms.

2. The IC package of claim 1, wherein the balls are Pb-free balls.

3. The IC package of claim 1, wherein the balls are polished using one of a mechanical polishing method and a chemical polishing method to have the substantially flat bottoms.

4. The IC package of claim 1, wherein the IC package is a ball grid array package.

5. A test apparatus comprising:
a plurality of channels;
a test board having a wiring pattern connected to the channels;
an IC socket having a plurality of Pogo pins respectively connected to lands of the wiring pattern; and
an IC package having balls, the balls having substantially flat bottoms contacting the Pogo pins.

6. The test apparatus of claim 5, wherein the Pogo pins of the IC socket have top ends that contact the balls of the ball grid array package, and the top ends are substantially flat.

7. The test apparatus of claim 5, wherein the Pogo pins of the IC socket include springs.

8. The test apparatus of claim 5, wherein the balls of the IC package are Pb-free balls.

9. The test apparatus of claim 5, wherein the balls of the IC package are polished using one of a mechanical polishing method and a chemical polishing method to have the substantially flat bottoms.

10. The test apparatus of claim 5, wherein the IC package is a ball grid array package.

11. A test apparatus comprising:
a plurality of channels;
a test board having a wiring pattern connected to the channels;
an IC socket having a plurality of Pogo pins respectively connected to lands of the wiring pattern;
a rubber plate including conductive elements contacting the Pogo pins, electrode pads being disposed on the conductive elements; and
an IC package having balls, the balls having substantially flat bottoms contacting the electrode pads of the rubber plate.

12. The test apparatus of claim 11, wherein the Pogo pins of the IC socket have top ends that contact the balls of the ball grid array package, and the top ends are substantially flat.

13. The test apparatus of claim 11, wherein the Pogo pins of the IC socket include springs.

14. The test apparatus of claim 11, wherein the balls of the IC package are Pb-free balls.

15. The test apparatus of claim 11, wherein the balls of the IC package are polished using one of a mechanical polishing method and a chemical polishing method to have the substantially flat bottoms.

16. The test apparatus of claim 11, wherein the IC package is a ball grid array package.

17. A method of manufacturing an IC package, the method comprising:
soldering ball grid array balls on a wafer that has completed a semiconductor manufacturing process;
leveling bottom surfaces of the ball grid array balls; and
vertically and horizontally sawing the wafer having the ball grid array balls whose bottom surfaces are leveled.

18. The method of claim 17, wherein the leveling is performed using one of a mechanical polishing method and a chemical polishing method.

19. The method of claim 17, wherein the vertically and horizontally sawing is performed using a diamond cutting method.
